(19) United States
(12) Patent Application Publication
(10) Pub. No.: US 2004/0001500 A1
(43) Pub. Date: Jan. 1, 2004

(54) Predictive tuning to avoid tuning delay

(76) Inventor: Michael J. Castillo, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/187,722

(22) Filed: Jul. 1, 2002

(51) Int. Cl. H04J 3/16

(52) U.S. Cl. 370/437

(57) ABSTRACT

Service providers generally seek to provide more channels and/or services over increasingly limited communication pathways, e.g., cable, Internet, etc. To do so, compression techniques may be used to compress transmissions. For example, a digital signal carried by a cable television cable may include multiple channels, each including a compressed video stream, such as an Moving Picture Experts Group (MPEG) data stream. While such compression facilitates maximizing usage of available bandwidth, a drawback to compression is that locking on to a new channel requires some portion of a channel to be collected before the channel can be presented. This collection takes time, and introduces a noticeable delay or “lag time” between selecting a new channel, and the new channel being presented. To help avoid a delay, various embodiments of the invention concern predictively buffering channels so that a request to change to a buffered channel results in an immediate presentation of buffered data.

### FIELD OF THE INVENTION

The invention generally relates to selecting presentations in an environment having a lag time between selecting a presentation and the presentation being presentable, and more particularly to predictively tuning a second tuner while presenting from a first tuner to allow immediate presentation from the second tuner.

### BACKGROUND

Analog radio, television, movies, and other audiovisual transmissions are slowly being replaced with digital environments, such as digital cable television, satellite television, satellite radio, etc. One advantage of digital transmissions is that the digital data may be compressed, allowing a higher quality picture to be transmitted in the same bandwidth as the analog transmissions. For example, in a video context, ISO/IEC (International Organization for Standardization/International Electrotechnical Commission) Moving Picture Experts Group (MPEG) compression techniques may be used to greatly compress video data. Although an oversimplification, rather than storing the contents of each frame in a video, for a particular sequence of video frames, MPEG generally operates by storing a base frame and then differences between successive video frames. Since many frames have common content, just storing difference data can greatly reduce storage needs.

Unfortunately, although compression allows a transmission to maximize available bandwidth, there are issues with switching between different compressed data streams. In a digital cable, satellite television, or Very High Speed Digital Subscriber Line (VDSL) context, for example, each cable cable/satellite channel may correspond to an MPEG compressed data stream, and switching data streams corresponds to changing channels. In order to switch from presenting a first MPEG data stream to present data from a new MPEG data stream, it is necessary to “lock on” to the new data stream, where locking on includes decoding the data stream and identifying a base frame from which to begin presenting the new data stream. Such locking on may take up to several seconds, resulting in an undesirable delay in changing data streams.

### BRIEF DESCRIPTION OF THE DRAWINGS

The features and advantages of the present invention will become apparent from the following detailed description of the present invention in which:

FIG. 1 illustrates an exemplary system in which a transmission head end and/or service provider communicates with devices having multiple tuners and a predictor for predictively tuning at least one of the tuners.

FIG. 2 is a flowchart according to one embodiment illustrating one exemplary embodiment for switching channels.

FIGS. 3-5 illustrate exemplary flowcharts of operations that may be performed by a predictor monitoring channel selections.

FIG. 6 illustrates a suitable computing environment in which certain aspects of the invention may be implemented.

### DETAILED DESCRIPTION

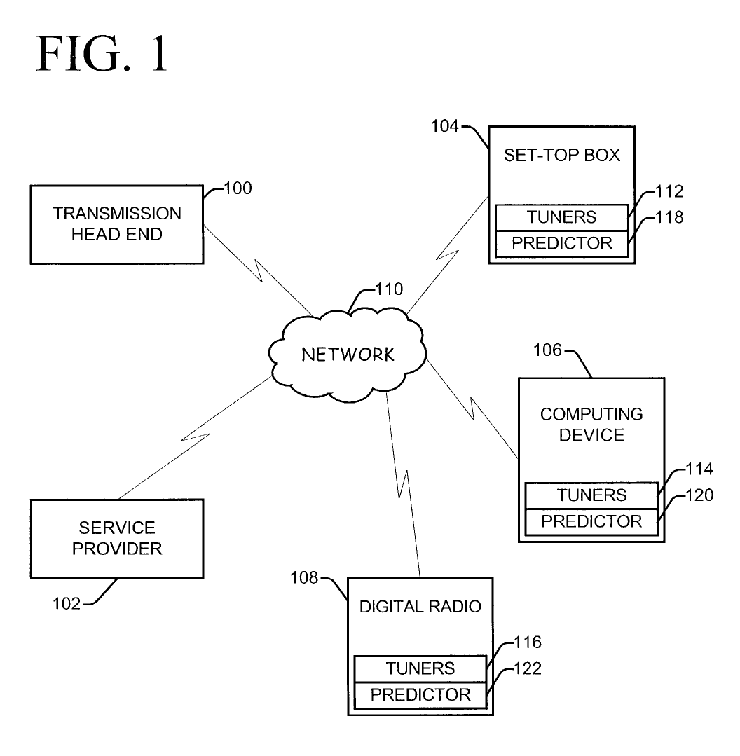

Obtaining more performance, or providing more services, with the same or fewer resources, is a common goal of data providers. Typically, to do so, compression techniques are employed to maximize usage of available bandwidth. To potentially avoid a synchronization lag time delay when switching between different compressed data streams, assuming multiple tuners are available, various embodiments of the invention concern predictively buffering data streams that are likely to be requested to be presented next, so that a switch to a predicted stream results in its immediate presentation. In this description and the claims that follow, the term “transmission” is intended to encompass different data distribution topologies, including a conventional arrangement such as illustrated in FIG. 1, as well as many-to-one, many-to-many, peer-to-peer, and other distribution arrangements. It will be appreciated that distribution may be of any data, including, for example, audio, video, computer programs, or other content. In this description and the claims that follow, the term “tuner” is intended to broadly encompass whatever technology or protocol is required to lock on to or otherwise acquire and/or decode a transmission or portion thereof.

FIG. 1 illustrates an exemplary system in which a transmission head end and/or service provider communicates with devices having multiple tuners and a predictor for predictively tuning at least one of the tuners. Such devices having multiple tuners may include a set top box 104, a computing device 106, a digital radio 108, as well as other devices not illustrated.

The service provider 102 may be a third-party corporation or other entity operating in conjunction with the transmission head end to supply services along with a transmission, for example, providing synchronized Internet content as just one example. The set top box 104, computing device 106, and digital radio 108 are intended to be exemplary devices in various contexts; for example, the set top box includes a cable television or satellite decoder, the computing device includes a personal digital assistant (PDA) or other hand held or portable device, a desktop computer, a laptop computer, an automobile, etc., and the digital radio includes stand alone devices receiving terrestrial transmissions, wireless networking, or other transmission technology, as well embedded digital radios within a computing device.

Each of the set top box 104, computing device 106, and digital radio 108, each respectively have multiple tuners 112-116 and a predictor 118-122. Depending on the transmission technology, a tuner is configured to tune in a channel, frequency range, or otherwise select, lock on to or decode a component of a transmission in accordance with the transmission technology. In the description that follows, the term “channel” is intended to represent a selectable portion of a transmission. Due to general familiarity, most examples will draw from a conventional digital cable television or satellite context, in which a set top box comprises two or more tuners for simultaneously tuning different channels, and at least one predictor.

The predictors 118-122 operate to predict a likely next channel to be selected. With this prediction, while a current channel is being displayed with a first tuner, other tuners can be tuned to other predicted channels to allow their immediate presentation if selected by the user. It will be appreciated that many different and simultaneous prediction techniques may be employed depending on the number of available additional tuners. Also, service provider 102 may operate, possibly in conjunction with the transmission head end 100, to provide historical usage data or other data that may be used by predictors 118-122 for making predictions.

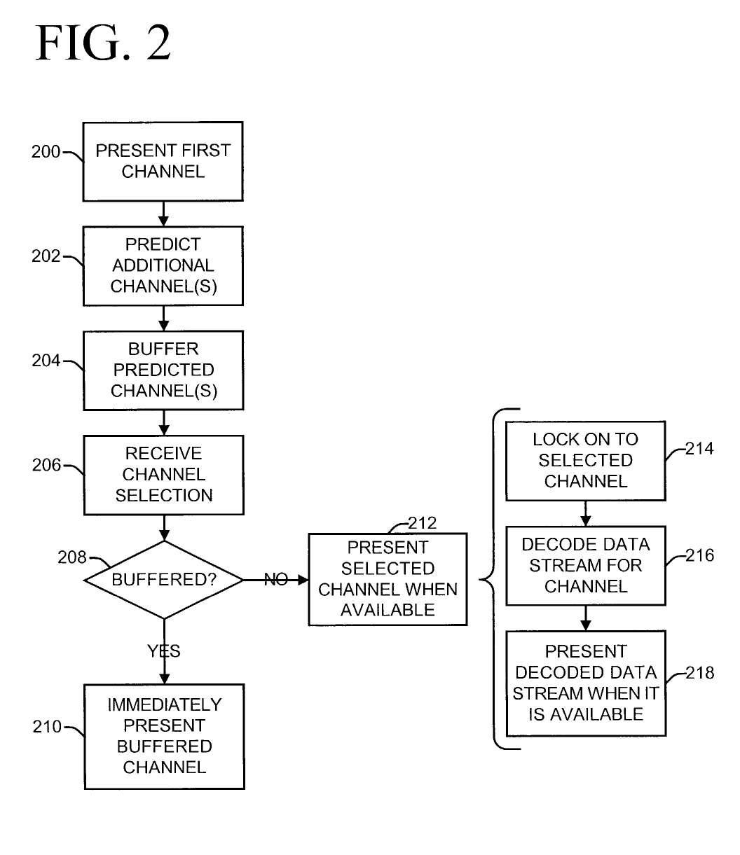

FIG. 2 is a flowchart according to one embodiment illustrating one exemplary embodiment for switching channels. Note that although various operations are illustrated in a particular sequence, it will be appreciated that many of the illustrated operations may occur in parallel or in alternate order.

A first operation is to present 200 a first channel. In a television environment utilizing a set top box, for example, a first tuner is tuned to a first channel and the first tuner output is connected to an appropriate input of a television (or other device configured to receive the output from the set top box).

An other operation is to predict 202 additional channels that might be selected next.

Predicted channels are then buffered 204 to allow their immediate presentation if selected, e.g. chosen for viewing on a television or other output device. It will be appreciated that depending on the nature of the data stream being buffered, buffering may require various decoding or other operations in order to construct data that may be presented, e.g., an MPEG stream may be decoded and made available for presentation on a television or other output device.

If a channel selection 206 is received, a test 208 may be performed to determine whether the selected channel has been predictively buffered. If so, then the buffered data is presented 210 immediately. If the channel was not buffered, then the selected channel is presented 212 normally, e.g. whenever it becomes available. In one embodiment, normal presentation of the channel includes locking 214 on to the selected channel, decoding 216 the data stream for the selected channel, and presenting 218 the decoded data stream once it is available.

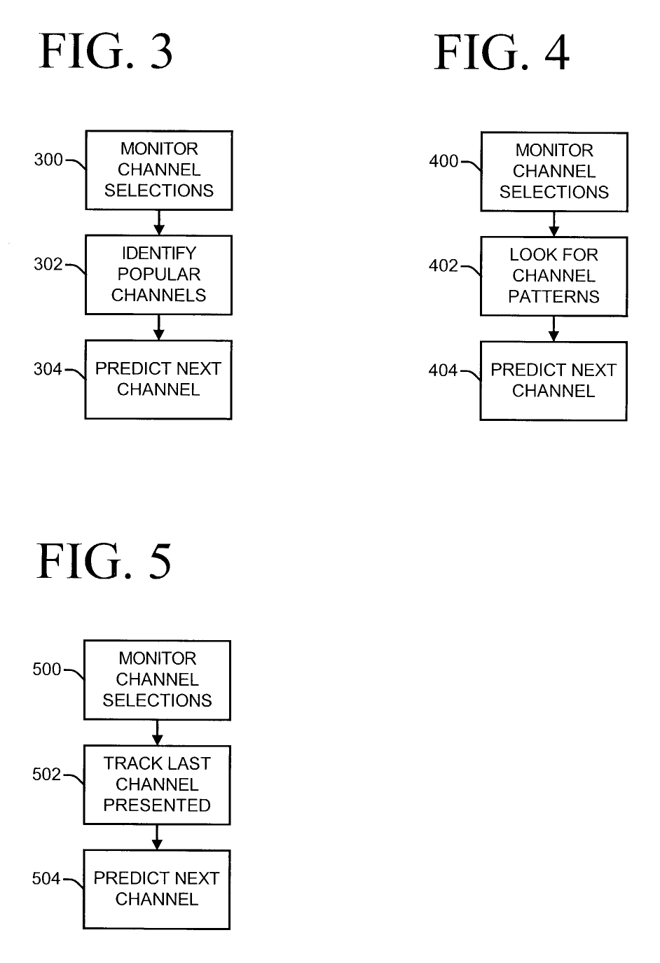

FIGS. 3-5 illustrate exemplary flowcharts of operations that may be performed by a predictor monitoring channel selections.

In a FIG. 3 embodiment, a predictor can monitor 300 channel selections, identify 302 channels that appear popular, and predict 304 the popular channels will likely be selected next. For example, in one embodiment, over time, a predictor can monitor watched channels in order to later predict channels likely to be directly selected, e.g., entered on a keypad, selected from a menu, etc., by a user.

In one embodiment, the predictor tracks the types of shows watched, such as news transmissions, and uses type information to predictively tune additional tuners to other channels presenting such shows, e.g., other news channels. In one embodiment, the predictor looks for channel groupings, or channel clusters. Thus, if when channel 5 is viewed, channels 7 and 9 are also frequently viewed as well, then these channels may be grouped so that watching any one of them may result in predictively buffering the other channels in the group. Any statistical relationship between the channels may be used to define a grouping.

In a FIG. 4 embodiment, a predictor can monitor 400 channel selections, identify 402 patterns to channel selections, and use the patterns to predict 404 the popular channels will likely be selected next. For example, in one embodiment, if a user appears to be “channel surfing,” e.g., simply sequentially channel changing up or down available channels, then the predictor would predict that the next channel in the series is likely to be selected next.

In a FIG. 5 embodiment, a predictor can monitor 500 channel selections, track 502 the last channel presented, and predict 504 a user is likely to return to the previously viewed channel.

It will be appreciated that many different prediction algorithms can be applied to determining one or more most likely channels to be selected next. For example, it may be determined that different blocks of time have different viewing habits that may be used to base or adjust predictions, e.g., from 9 AM through 3 PM, talk shows may be primarily viewed, while from 3 PM through 6 PM children shows are primarily viewed, and from 6 PM through 8 PM news broadcasts are viewed. Also, multiple predictions may be determined, and their predictions ranked so that only the most likely predictions are applied to available additional tuners. In one embodiment (not illustrated) a user identity is tracked, such as by a login or biometric input, so that individual predictions can be maintained across different uses of a device.

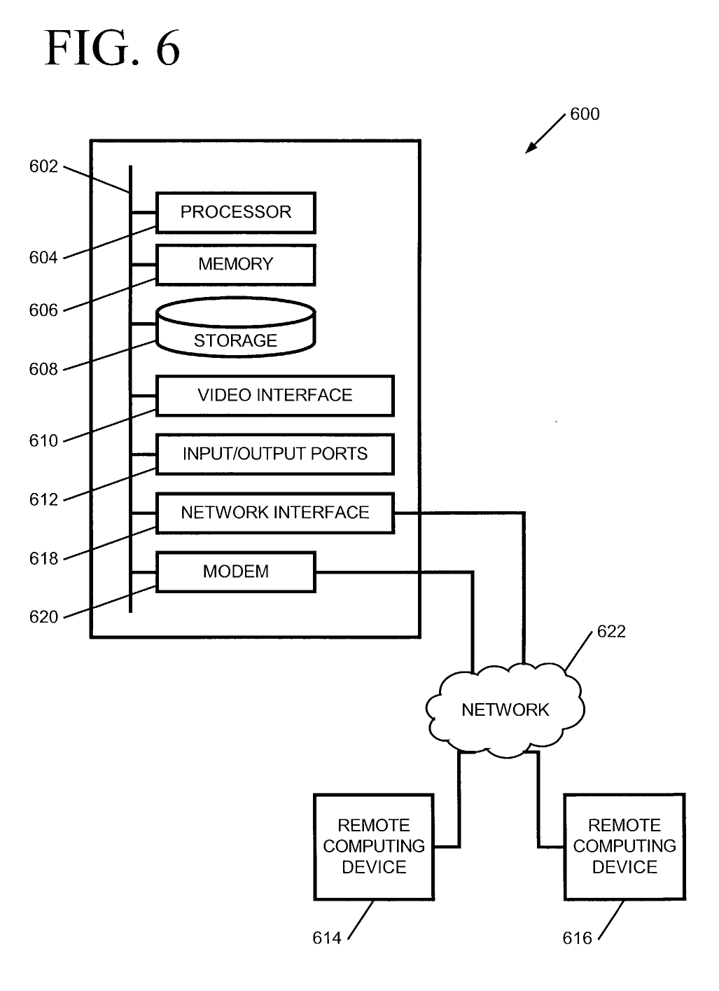

FIG. 6 and the following discussion are intended to provide a brief, general description of a suitable computing environment in which certain aspects of the illustrated invention may be implemented. For example, the illustrated environment includes a machine 600 which may embody the set top box 104, computing device 106, digital radio of FIG. 1, or other device. As used herein, the term “machine” includes a single machine, such as a computer, handheld device, etc., or a system of communicatively coupled machines or devices.

Typically, the machine 600 includes a system bus 602 to which is attached processors 604, a memory 606 (e.g., random access memory (RAM), read-only memory (ROM), or other state preserving medium), storage devices 608, a video interface 610, and input/output interface ports 612. The machine may be controlled, at least in part, by input from conventional input devices, such as keyboards, mice, joysticks, as well as directives received from another machine, interaction with a virtual reality (VR) environment, biometric feedback, or other input source or signal.

The machine may also include embedded controllers, such as Generic or Programmable Logic Devices or Arrays, Application Specific Integrated Circuits, single-chip computers, smart cards, or the like, and the machine is expected to operate in a networked environment using physical and/or logical connections to one or more remote machines 614, 616 through a network interface 618, modem 620, or other data pathway. Machines may be interconnected by way of a wired or wireless network 622, such as the network 110 of FIG. 1, an intranet, the Internet, local area networks, personal area networks, and wide area networks. It will be appreciated that network 622 may utilize various short range or long range wired or wireless carriers, including cellular, cable, laser, satellite, microwave, Bluetooth, radio frequency (RF), optical, and infrared.

The invention may be described by reference to or in conjunction with program modules, including functions, procedures, data structures, application programs, etc. for performing tasks, or defining abstract data types or low-level hardware contexts. Program modules may be stored in memory 606 and/or storage devices 608 and associated storage media, e.g., hard-drives, floppy-disks, optical storage, magnetic cassettes, tapes, flash memory cards, memory sticks, digital video disks, biological storage. Program modules may be delivered over transmission environments, including network 622, in the form of packets, serial data, parallel data, propagated signals, etc. Program modules may be used in a compressed or encrypted format, and may be used in a distributed environment and stored in local and/or remote memory, for access by single and multi-processor machines, portable computers, handheld devices, e.g., Personal Digital Assistants (PDAs), cellular telephones, etc.

Thus, for example, with respect to the illustrated embodiments, assuming machine 600 embodies the set top box 104 of FIG. 1, then remote machine 614 may be a transmitter, such as for the transmission head end 100, providing audio, audiovisual, and perhaps other data streams over the network 622. Remote machine 616 may be a digital radio 108 receiving the audio data streams over the network. It will be appreciated that remote machines 614, 616 may be configured like machine 600, and therefore include many or all of the elements discussed for machine 600.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

What is claimed is:

1. A method for improving channel selection in a transmission environment in which there is a noticeable delay before a selected channel is decoded and adequately perceivable, the method comprising:
providing a plurality of tuners for tuning channels of the transmission environment;
presenting a first channel with a first one of the tuners; and
before receiving a new channel selection, predictively buffering a second channel with a second one of the tuners.

2. The method of claim 1, wherein predictively buffering the second channel comprises:
predicting the second channel to be a likely new channel selection;
tuning the second tuner to the second channel, the tuning determining a data stream corresponding to the second channel; and
decoding the data stream for the second channel.

3. The method of claim 2, further comprising:
wherein the data stream corresponds to an audiovisual presentation having a first frame and a second frame; and
wherein the data stream is a compressed representation of the audiovisual presentation comprising a base frame corresponding to the first frame, and a differential frame encoding differences between the first frame and the second frame.

4. The method of claim 2, further comprising:
receiving the channel change request identifying the likely next-channel; and
immediately presenting the decoded data stream for the likely next-channel.

5. The method of claim 1, further comprising:
receiving a channel change request identifying the likely next-channel; and
immediately presenting the second channel.

6. The method of claim 1, further comprising:
while presenting the first channel, predictively buffering a third channel with a third one of the tuners.

7. The method of claim 1, further comprising:
tracking frequently-visited channels; and
tuning selected ones of the tuners to the frequently-visited channels.

8. The method of claim 1, in which the first channel is one of a series of channels, and wherein predictively buffering the second channel comprises:
tuning the second one of the tuners to an adjacent channel in the series.

9. The method of claim 1, wherein predictively buffering the second channel comprises:
tuning the second one of the tuners to a last-viewed channel.

10. A system for receiving a propagated signal encoding plural channels, the system comprising:
a first tuner of plural tuners operable to present a first channel of the propagated signal;
a second tuner of plural tuners operable to decode a second channel of the propagated signal;
a channel predictor operable to predict a second channel of the propagated signal and to direct the second tuner to decode the second channel; and
a buffer for buffering a decoded second channel.

11. The system of claim 10, further comprising:
an input for receiving a new channel selection;
a comparator to compare whether the new channel selection is the predicted channel; and
a switch operable to immediately present the buffer based on a result of the comparator.

12. The system of claim 10, further comprising:
a third tuner operable to decode a third channel of the propagated signal;
wherein the channel predictor is further operable to predict the third channel and to direct the third tuner to decode the third channel.

13. The system of claim 10, wherein the channel predictor is further operable to track frequently-visited channels, and tune selected ones of the tuners to the frequently-visited channels.

14. The system of claim 10, in which the first channel is one of a series of channels, and wherein the channel predictor is further operable to tune the second one of the tuners to an adjacent channel in the series.

15. The system of claim 10, in which the first channel is one of a series of channels, and wherein the channel predictor is further operable to tune the second one of the tuners to a last-viewed channel.

16. An article, comprising:
a machine-accessible media having associated data for improving channel selection in a transmission environment in which there is a noticeable delay before a selected channel is decoded and adequately perceivable, wherein the data, when accessed, results in a machine performing:
providing a plurality of tuners for tuning channels of the transmission environment;
presenting a first channel with a first one of the tuners; and
before receiving a new channel selection, predictively buffering a second channel with a second one of the tuners.

17. The article of claim 16 wherein the data for predictively buffering the second channel further comprises data, which when accessed by the machine, results in the machine performing:
predicting the second channel to be a likely new channel selection;
tuning the second tuner to the second channel, the tuning determining a data stream corresponding to the second channel; and
decoding the data stream for the second channel.

18. The article of claim 16 wherein the machine-accessible media further includes data, when accessed by the machine, results in the machine performing:
receiving the channel change request identifying the likely next-channel; and
immediately presenting the decoded data stream for the likely next-channel.

18. The article of claim 16 wherein the machine-accessible media further includes data, when accessed by the machine, results in the machine performing:
receiving a channel change request identifying the likely next-channel; and
immediately presenting the second channel.

19. The article of claim 16 wherein the machine-accessible media further includes data, when accessed by the machine, results in the machine performing:
while presenting the first channel, predictively buffering a third channel with a third one of the tuners.

20. The article of claim 16 wherein the machine-accessible media further includes data, when accessed by the machine, results in the machine performing:
tracking frequently-visited channels; and
tuning selected ones of the tuners to the frequently-visited channels.

21. The article of claim 16 in which the first channel is one of a series of channels, and wherein the machine-accessible media further includes data, when accessed by the machine, results in the machine performing:
tuning the second one of the tuners to an adjacent channel in the series.

22. The article of claim 16 wherein the data for predictively buffering the second channel further comprises data, which when accessed by the machine, results in the machine performing:
tuning the second one of the tuners to a last-viewed channel.
